(19) United States
(12) Patent Application Publication
(10) Pub. No.: US 2014/0344039 A1
(43) Pub. Date: Nov. 20, 2014

(54) Network Based Discussion Forum System and Method with Means for Improving Post Positioning and Debater Status by Trading Arguments, Purchasing, Acquiring and Trading Points

(71) Applicant: Henryk A. Kowalczyk, Bolingbrook, IL (US)

(72) Inventor: Henryk A. Kowalczyk, Bolingbrook, IL (US)

(73) Assignee: VIRTUAL AGORA, LTD, Bolingbrook, IL (US)

(21) Appl. No.: 13/896,556

(22) Filed: May 17, 2013

(51) Int. Cl. G06Q 50/00; G06Q 30/02

(52) U.S. Cl. CPC G06Q 50/01; G06Q 30/0217
USPC 705/14.19

(57) ABSTRACT

Method and system for online network based debate forums by using opinion trading exchange. Discussions are conducted in a format of challenges, wherein, in order to open the challenge or/and comment to it, participants are required to make an investment (bet) in their views in a forum currency; wherein the starting capital can be granted, bought with real currency or earned by participation in forum activities. After a predetermined time the challenge is decided as true or false, and participants earn or lose their investment depending upon the position they selected. Objectivity of the moderators can be challenged as well. User's position is defined by the amount of the forum currency owned. The system maintains searchable database with the history of previous challenges. The invented opinion trading algorithm invokes debates to gravitate toward conclusions based upon verifiable facts and logic.

### PRIOR CLAIMS

Priority is herewith claimed to U.S. Provisional Patent Application No. 61/650,054, filed on May 22, 2012.

### FIELD OF THE INVENTION

The present invention relates to the field of digital networks, including but not limited to the internet, as well as discussion forums, lists, social media groups and platforms, groupings, and knowledge management; where the user may be required to earn his or her position by trading arguments in structured and timed debates; more particularly, those wherein the user must pay in order to place a post and then the posts are rated and a winner earns and the loser loses funds invested in the post.

### BACKGROUND OF THE INVENTION

Currently, in the marketplace, there are available wide varieties of internet based discussion groups, forums, and listings. These discussion groups consist generally of comments submitted by either the public or specific users wherein other users of that system, or even the general public, may read each post and then vote on whether the post is “liked” or given a “thumbs up,” which pushes the post toward the top of the list, or whether the post or commentary is “disliked” such that it will fall down the list toward the bottom. Some systems have posts valuation and recommendation made arbitrarily by the forum operators.

Often, this system results in a very stale format where the very first or top views seen by a reader will always get the most ratings. In this format, directed primarily by viewers' choices, viewpoints reflecting ideological leaning of the majority of the forum members are elevated, while opposing viewpoints are discarded. For this reason, in most present interned based discussion forums debates between people of opposite views are weak and non-conclusive. Often, participants expressing views opposing those dominating in the group are asked or forced to leave the group. Instead of bridging people of diverse views most discussion groups deepen polarity.

In reviewing the prior art, there are patents which refer or relate to internet discussion boards and groups and rating posts and present lists of rated posts. U.S. Pat. No. 8,335,848 issued to Wenig, et al. discloses the use of an Event Tracking and Replay (ETR) system where network data is captured at a first location and transmitted to a second location. User interface events associated with the same transaction are separately captured at a second user terminal location. The ETR system captures both network data exchanged between client and web application during a web session as well as capturing the user information (UI) events that are entered locally by a user when interacting with the network data. The system utilizes time based analytics, yet it does not disclose any new method or system for using of ETR to improve functionally of discussions on the debate forums.

U.S. Pat. No. 8,112,478 issued to Carrer, et al. discloses the use of a system for sharing information between newsgroups and email applications. An RSS (Rich Site Summary) reader is layered over an email system to provide one convenient place for an user's email and for discussion in newsgroups. Users can then send emails to participate in various forums. The discussions may exist as folders in an existing email program. The Carrer system may also implement read limits or number of messages per day, length of message, etc. Business logic may be implemented to perform certain tasks such as enforcing policies. The system may also track whether items are read or unread in the system. However, this system does not improve upon the positioning of posts and status of debaters within the system by any method or process of assigning a value to the posts and trading these values.

U.S. Pat. No. 8,024,408 issued to Wang Baldonado, et al. discloses the use of a forum monitoring device wherein users may elect to create child forums in a discussion group. The system uses a forum spawning device wherein at least one criteria or rule is utilized to create child forums. An information monitoring device is used to implement the spawning system. In this system users are queried when at least one set of rules is satisfied, then the system creates the new discussion forum and auto subscribes the list of contributors according to the new forum request. A user may send suggestions to all posters that may be voted on within the system. However, this system does not allow users to advance their posts or positions by winning debates, or to pay for or trade points to improve post positioning within the system.

U.S. Pat. No. 7,797,237 issued to Kim discloses the use of a financial transaction system providing real time authentication to prevent leakage of information, fund diversion and misappropriation, thereby increasing transaction security and allowing for either wired or wireless payments.

U.S. Pat. No. 7,478,129 issued to Chemtob discloses a system for enhancing group interactions, group activities and group environments. It may be used for high tech business meetings, on line classrooms, conferences, group counseling efforts, internet trade shows, private meeting places, etc. A user may engage in different types of communications (whisper, normal voice, open or hidden text, icons, emoticons, etc.) The system has the ability to group, subgroup or rejoin a main group. The system may specify a particular or grouped target of the user's message. The system may create “communication flows” which are to be displayed either graphically or textually for all to see. The Chemtob system allows for virtual group activities and interactions, as well as structured learning programs, virtual textbooks, notebooks, video displays, file sharing, virtual study groups and group document preparation, etc.

The Chemtob system also discloses it may be used for Goal Attainment Support groups such as AA, NA, etc. as well as the ability to simulate a real life experience playing board and card games in a group environment. The system may also be constructed so as to provide a virtual meeting space wherein all participants can be seen as if sitting around a large conference table. The system can create a perfect virtual online classroom where students can take notes, sit together, exchange notes, ask questions, and a lecturer can use a virtual chalkboard. Private rooms may be used for friends and family for group activities such as putting together a puzzle, playing a board game, reviewing and arranging family pictures into albums. A user can build a virtual office for the user within the system by selecting office furniture and equipment. The system may even provide a registry for leaders and other professionals to advertise their services within the system. Nonetheless, the Chemtob system focuses on technicalities of opinion exchange within internet forum groups and does not disclose methods for improving quality of arguments presented and abilities to reach conclusions.

U.S. Pat. No. 7,310,658 issued to Giles discloses a method and system to operate an electronic forum where users may post on various topics and also receive emails when a response is received to a prior posting. Responses to a topic may be nested, and they may receive a date and timestamp. An agent is provided that allows for three functions: a tracking view, a query database for new responses, and sending a tracking email to each user having an interest in the new response. Nonetheless, the Giles patent does not disclose methods for improving debates and discussions within internet forum groups.

U.S. Pat. No. 7,305,436 issued to Willis discloses a viewing system which allows individual users to view videos containing pre-categorized content (iViews) in order to interact with a discussion forum. IViews are produced both on expected and actual content. The system may incrementally learn the viewer's preferences. The user can set preferences to certain media types or sources (CNN, weather, sports, etc.) as desired and set the length of time for each media request. By rating prior iViews, the system acquires information to personalize future media asset views to the user. Posted comments with pre-selected topics of interest to the particular user will appear first. In such a manner, differing articles and videos and news stories may be linked to discussion forums which were heretofore unknown to the user. However, this system is designed to suit user preferences, and it is not necessarily to improve the method of opinion exchanges between the users.

U.S. Pat. No. 6,557,027 issued to Cragun discloses a system and method for managing on line discussions wherein a first message may be displayed in a window having a first format type, while a second message may be display in a window having a second format type. The Cragun system involves, in one embodiment two Chat servers communicating with each other and two work stations, which may be dumb or smart terminals connected to a CPU. A chat client program is provided with a GUI interface for facilitating entry of messages. The system has means for associating comments with particular sub topics, a visual presentation clearly distinguishing comments according to sub topic, and facilities for creating, destroying and combining sub topics. While this system discloses means and methods for storing, arranging and displaying chats or posts, it does not disclose any means for improving the merit of the debates by trading values assigned to posts.

U.S. Pat. No. 6,347,332 issued to Malet discloses the use of a system which helps individuals filter and evaluate conflicting information through a process of online debate. It includes a rating process, community services, and mechanisms for site organization and operation and user interfaces. It helps users to quickly understand key points of argument without time consuming research, to identify key facts or assumptions without thinking about extraneous and misleading rhetoric and it supports additional research to explore specific points of interest in more detail. The core of the system is the Argument Base and a Rating Process. The Rating Process operates to allow the best Arguments and Evidence to be easily identified as well as key points of controversy in a complex debate. Ratings in this system must be conserved and allocated efficiently by the participants in order to maximize their interests. The database may include a Reference A library, a Community Directory, Comments and Evaluations. The Rating Process weighs Arguments, Reference and users. Community Services control access to the Debates by utilizing Credentials and contributions. Users interact with the Argument Base via a T Account interface showing both pro and con Arguments and Evidence sorted by strength. Evaluations include numerical ratings that are used by the Rating Process to filter and prioritize objects in the Reference Library and the Argument base. Other items in the Database include Comments, Topics and Issues. It is envisioned that there can be differing levels of ratings, including Summary ratings for both members and propositions. Direct ratings include: propositions, relationships, the reference library items, references, members. Members may have Contribution Weights. Each member has only one vote and that is public information. The system may have both visitors and members. Members may be public or anonymous, but a penalty may be imposed for anonymity. Members will get Contribution Weights. An Issue Room Moderator may be provided who has intellectual control over an Issue Room. Editors and Member Editors may also be provided. Each Issue Room will have a Library and a Discussion Archive. Issue Rooms may be public, restricted, private or Private Label. Discussion may be provided with Editorial Oversight, Public Comment or Fully Moderated. Revenue modes may include Membership and Subscriptions, Advertising and Sponsorship (as sold by each Issue Room) and Library Access as charged to a member's library card. While this system is also a system for rating posts, as in the prior art regarding debate and discussion groups, it is nonetheless founded on an arbitrary set rating process, not on a self-correcting trading mechanism. In particular, it still does not allow for the ability of the user to invest in the debated issue, and then elevate or lower the user's position depending upon if the argument was won or lost correspondingly.

Accordingly, nowhere in the prior art is there seen a system or method where persons of opposing views can invest or bet some of their assets in the assumption that some statements are true or false; can trade their views by engaging in the process of investing their own points or real currency in the challenges presented for the debate, and having their position moved up or down depending upon the challenges resolved as true or false. Moreover, there is no system where forum members can advance their position or position of their posts by either purchasing points or engaging inmarketing activities as playing a sponsored game, or learning activities as taking a test proving knowledge of a certain subject. Further, there is no system where topics are opened for a predetermined time and then closed, a moderator ensures that posts are rated and based upon facts and known science. Also, there are no discussion forums where objectivity of a moderator can be formally challenged. Furthermore, there is no network based debate forum with the system or method stimulating fact and reason based opinions floating to the top. There is no known such a debate forum, with the trading mechanism defining the status of the debaters. There is no known such a debate forum where the rules reward participants for understanding views of others, for learning, and for changing views.

### SUMMARY OF THE INVENTION

With the present invention, a process is presented which uses a digital communication network, as for example, the internet, an intranet, a cellular phone network, etc. based opinion exchange between individuals of opposing viewpoints. The debate is divided into time limited challenges, where in order to open the challenge and/or comment upon it, participants are required to make an investment in their view in the forum currency (which could be real currency or score points), whereby the forum currency may be given to the user, earned by the user by investing in winning challenges, and may be purchased by the user with real currency, or obtained for activities, such as viewing ads, playing certain types of games, or any activity that the forum operator system benefits from or has chosen to create reward points with the forum currency.

Typically, a new user joining the forum is given a pre-determined amount of starting capital in the forum currency, or the new user may purchase forum currency with real currency, or the user may earn it by engaging in activities designed by the forum operators. Then the user invests some of the original capital in posting challenges and comments to challenges of others. Challenges, in order to be posted for the debate need to be phrased in a form of a thesis that can be proven true or false. Challenges are opened for discussion for a predetermined time, and then the moderator, based on the arguments presented in the challenge, not on knowledge available otherwise, resolves the challenge as true or false. If the challenge is decided as true, the challenger earns the amount invested in posting the challenge, and other users posting comments supporting the challenge resolved as true earn the amounts invested in their comments. The users posting comments opposing the challenge resolved as true lose their investment in this challenge. If the challenge is resolved false, the challenger loses the amount of forum currency invested in the challenge. Other users posting comments supporting the challenge resolved as false lose their investment as well. The users posting comments opposing this challenge resolves as false gain their investment.

In such a manner, users learn to put their money where their mouth is; they become more realistic in their choices, and make decisions more likely based on facts and rational reasoning.

It is anticipated that the challenges posted for debate should be practical ones where empirical data can be identified. Some ideas or concepts are hard to prove based on facts, such as “is there a God?”; however, resolution of existential problems can be resolved without the determination of that question.

Users may participate in this inventive debate forum by personal computer, laptop, tablet, cell phone, smart phone, and the like, or any device with a processing unit which is accessible to the digital communication network, such as the internet, intranet or cellular network.

Once the user has funded his points or revenue account, whenever the user is in the debate forum and wishes to make a post, the user will need to commit or invest some of the points or funds from in the user's account to place a post on the system. The post could be, as a challenge opening a new subject for the debate, or as a comment supporting or opposing the challenge currently opened for debate. The system does not allow comments without declaration for or against the challenge. A user can make one comment supporting some aspect of the challenge, and another comments against other aspects of the same challenge.

The present inventive system is also provided with moderators who will manage the discussion group. In particular, any new posted challenge can be open for the debate only after it has been checked for meeting all formal criteria preset by the forum operator. By the end of the predetermined time, the moderator makes a decision if, based on the arguments presented in the debate not on knowledge available otherwise, a given challenge is false or true. Moderators could be selected arbitrarily by the forum operators, or they could be selected from among the forum members. A forum member serving as the moderator cannot invest in the challenge which he or she moderates. In particular, a posted challenge could consist of merely questioning objectivity of any moderator. In such a manner, the users will be able to vote to remove or dismiss any moderator from a forum where the forum members believe there is bias. When posting a challenge a user can ask a particular moderator to moderate this challenge. Furthermore, any user may select a moderator that user prefers by simply paying for a particular moderator. In such a fashion, moderator resources may be allocated according to moderator popularity on the system. Users will have to pay more for more knowledgeable and popular moderators.

Because the success of the system depends upon the users recognition that their opinions are respected moderators have an invested interest in being objective and forum operators have an invested interest in electing and maintaining fact based moderators who make decisions based upon well researched arguments and opinions and not on their personal preferences. Thus, the present inventive discussion forum system creates the method that should result in more truth, accuracy, knowledge and wisdom among its users, unlike other forum discussion websites which tend to group users sharing the same views and rarely changing anyone's opinion.

The inventive network based discussion system and method is highly adaptable. It can be used to conduct political debates on all nationwide issues as immigration reform or healthcare reform; it could be used to debate issues in local communities, community groups as homeowners associations, or church groups; it could be used as a part of the election process on all levels, allowing voters to question quantitatively positions of the candidates; it can be used for entertainment venues as TV shows or computer video games; also, it can be used for educational purposes in schools and academia; lastly, it can be used by corporations in conducting creative debates (often called “brainstorming”) over the network and much more precisely than ever before.

The above summary of the invention should not be considered as limiting the invention in any manner, and the following objects and further descriptions and practices typically employed in the relevant art should be considered as part of this summary of the invention.

### OBJECTS OF THE INVENTION

Thus, it is one primary object of the present invention to provide an improved network based debate and discussion forum system wherein participants of the system may open an account with the system and purchase, earn, or be granted starting capital in the forum currency (real currency or score points) in order to be able to post in the discussion on a selected topic.

It is a further primary object of the present invention to provide an improved network based debate method and system wherein a debate in the form of a challenge may be opened for a predetermined period of time, and then determined by the moderator as true or false based on the facts presented in the challenge and comments to the challenge, but not on the knowledge available to the moderator otherwise.

It is yet an additional primary object of the present invention to provide an improved network based debate and discussion forum wherein the users are required to invest some of their forum currency in order to make a challenge, and then they earn the amount invested in the challenge if the challenge is resolved as being true, but they lose the amount invested in the challenge, if the challenge is resolved as being false.

Still a further additional primary object of the present invention is to allow the users posting comments to a challenge to declare if they support the challenge or oppose the challenge, and then these users may be required to invest some of their forum currency in order to post any comments such that they will win their amount invested if their comment supported the winning challenge or opposed the losing challenge, or they lose the amount invested if their comment supported the losing challenge or opposed the winning challenge.

It is yet an additional primary object of the present invention to provide a debate and discussion forum wherein the same issue may be presented for debate endlessly as long as users believe there are new facts and arguments worth consideration.

Yet a further primary object of the present invention is to provide a debate and discussion forum wherein an endless number of challenges can be conducted on the forum concurrently.

Still it is an additional primary object of the present invention is to provide a debate and discussion forum wherein an archival database of the past challenges is maintained by the forum operator and available for searches by the users.

It is yet a further primary object of the present invention is to provide a debate and discussion forum wherein the forum operators provide reference data in variety of online documents, libraries, images, links and videos, available for users.

It is an additional primary object of the present invention to provide a debate and discussion forum wherein the forum operators can use artificial intelligence software to analyze behavior of the forum users and use the results for enhancing the forum operation and for marketing purposes.

It is still an additional primary object of the present invention to provide an improved debate and discussion forum wherein the users may engage in a variety of revenue generating activities in order to earn points to post, including but not limited to: view ads, watch movie trailers, take product surveys, print out coupons for featured products and services, play demo computer or video games, etc.

It is still an additional primary object of the present invention to provide an improved debate and discussion forum wherein the users may earn score points by engaging in activities promoted by forum operators, as for example taking tests proving knowledge of arguments of the opposite side.

Still a further primary object of the present invention is to provide a debate and discussion forum wherein the objectivity of the moderator can be questioned in a form of a challenge as defined above, and the moderator losing such challenge loses the moderator status, but may open a new challenge in order to regain the moderator's status.

An additional primary object of the present invention is to provide a debate and discussion forum wherein moderators can be assigned by the forum operators or selected from the high ranking users meeting some agreed formal criteria.

Yet a further primary object of the present invention is to provide a debate and discussion forum wherein users are encouraged to post challenges in form of statements verifiable with facts.

A further primary object of the present invention is to provide a debate and discussion forum wherein users are encouraged to question their own views, analyze and understand the views of others such that they are rewarded when they change their views based on the new knowledge acquired.

It is still a further primary object of the present invention is to provide a debate and discussion forum which includes a positive feedback mechanism, where an accumulation of experiences gradually weeds out erroneous views based on the prejudices, irrational beliefs and an inaccurate data, while elevating accurate views to the top of the fora based on verifiable facts and solid science.

Yet an additional primary object of the present invention is to provide a debate and discussion forum wherein there is provided a structured format for constructive fact based debates between people of opposing ideological values.

Yet an additional primary object of the present invention is to provide a debate and discussion forum system wherein the trading methods used stipulates that views based on facts and reason gradually prevail in discussions.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a schematic drawing of the present inventive system, improved debate and discussion forum with user account funding and argument trading algorithm.

FIG. 2 is a flow chart drawing of the present inventive method, improved debate and discussion forum with user funding and trading mechanism.

### DETAILED DESCRIPTION OF THE DRAWINGS

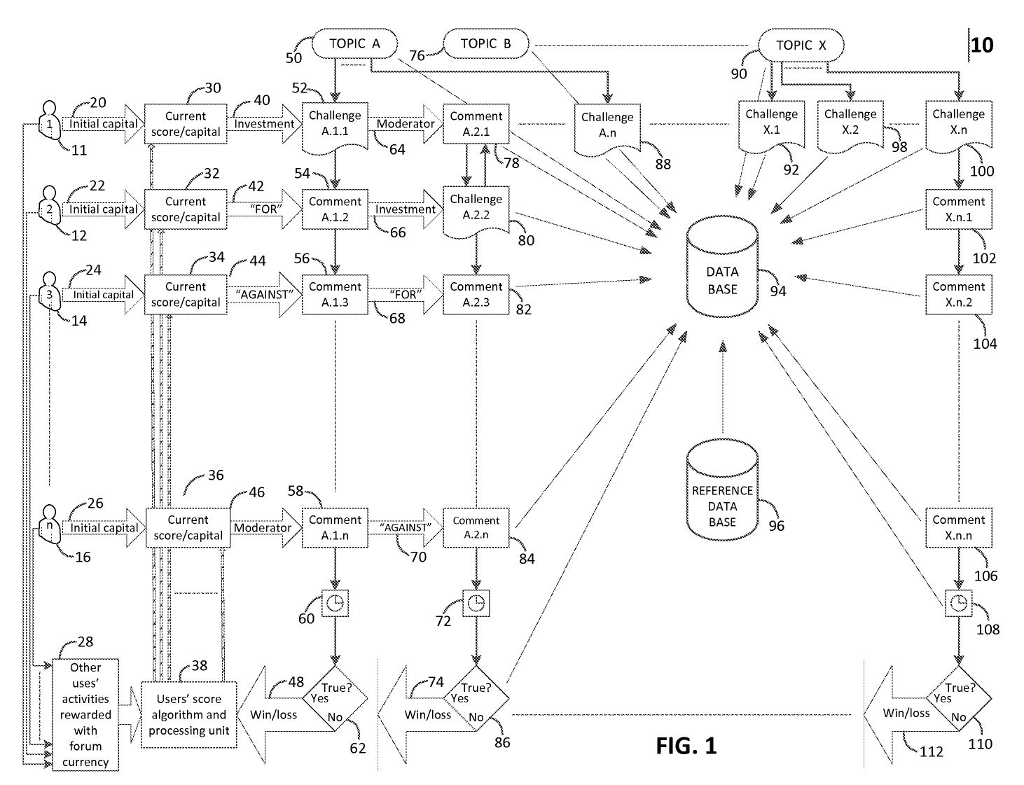

Shown now in FIG. 1 is the present inventive system Network Based Discussion Forum System and Method with Means for Improving Post Positioning and Debater Status by Arguments Trading, System 10 showing a plurality of users: Player 1-11, Player 2-12, Player 3-14, and Player n-16. Each of these players has become a member of the Network Based Discussion Forum and has created their own ID and passwords. Each of Player 1-11, Player 2-12, Player 3-14 and Player n-16 has also funded his or her account either with forum currency either granted at the time of joining the forum, purchased with real currency, or acquired by participating in marketing event, or any other activity selected by the forum operators as rewarded with forum currency. The initial capitalization for each Player is shown on FIG. 1 as follows: Player 1-11 has provided an initial capital amount 20, Player 2-12 has provided an initial capital amount 22, Player 3-14 has provided an initial capital amount 24. Player n-16 has provided an initial capital amount 26.

After the accounts of each user have been funded users 11, 12, 14 and 16 may post a statement in a form of a thesis, called a challenge, or can post comments “FOR” or “AGAINST” to challenges posted by others. Both, posting a challenge or a comment to any challenge require investment (bet) in the forum currency.

As shown in FIG. 1, Player 1-11 has chosen to open Challenge A.1.1-52 in the TOPIC A-50 by investing 40 in the forum currency. Player 2-12 commented 54 supporting this challenge an invested amount 42 in the truthfulness of the challenge 52. Player 3-14 commented 56 against the thesis of the Challenge A.1.1, and invested 44 in the bet that the challenge 52 will be proven false. Player n-16 served as a moderator on this challenge. The moderator can make comments 58, but cannot make an investment in the challenge him or her moderates; the investment 46 in the comment 58 to the challenge 52 is zero.

The challenge is debated for the predetermined time, and after the debate time expires 60, the moderator decides 62 if the challenge is “TRUE” or “FALSE” basing only on the arguments presented in the debate, not on the knowledge available to the moderator otherwise. If the challenge is decided “TRUE” Player 1-11 and Player 2-12 gain the amount equal the amount invested, but Player 3-14 loses the amount invested. If the challenge is decided as “FALSE” Player 1-11 and Player 2-12 lose their investment and Player 3-14 gains the amount equal to the investment made in the comment claiming falsehood of the challenge 52. Each debater can make many comments to each challenge, in particular a debater can make a comment supporting some aspect of the challenge and opposing another aspect of the challenge. A user posting a challenge can post comments to his or her challenge as well. After the challenge is closed, gains and losses are calculated, 48, and the system processing unit 38 credits and debits users accounts accordingly.

Multiple challenges can be placed concurrently. For example Player 2-12 opens challenge A.2.2-80 under the TOPIC A-50, investing 66 in the truthfulness of this challenge. In this instance, Player 1-11 serves as the moderator; his or her comments 78 do not require investment; 64 is equal zero. Player 3-14 invests 68 “FOR” and Player n-16 invests 70 in the comment 84 “AGAINST” the truthfulness of the challenge A.2.2-80. After the debate time 72 expires, the moderator resolves the challenge 86 and loses and gains are calculated, 74, and users' accounts are credited and debited accordingly, 38.

After the challenge closing, gains and losses are credited or debited to the users' accounts. After the first two challenges, player 1-11 has a current score 30 as a sum of the initial capital 20 and the gain or loss of investment 40 in the challenge 52. Player 2-12 has a current score 32 as a sum of the initial capital 22, the gain or loss of investment 42 in the comment 54, and the gain or loss of the investment 66 in the challenge 80. Player 3-14 has a current score 34, as a sum of the initial investment 24, the gain or loss of the investment 44 in the comment 56, and the gain or loss of the investment 68 in the comment 82. Likewise, Player n-16, has a current score 36 as a sum of the initial investment 26, and the gain or loss of the investment 70 in the comment 84.

Under each topic many challenges can be open, 88, where he number of challenges n is unlimited; new challenges can be open as long as users want to debate them. Forum operators can open more topics for debate, 76, and 90; where X is limited only by the forum operators desire to streamline debates by avoiding numerous topics covering the same subject. As it is shown in the example for TOPIC X-90, every topic can have unlimited number of challenges as 92, 98, and 100. For every challenge users can post unlimited number of comments as 102, 104, and 106. Every challenge is debated for a limited time 108, then the truthfulness of the challenge is decided by a moderator 110; after that gains and losses are calculated 112, and then credited or debited 38 to the users' accounts.

Users can improve their score by participating in other activities 28. It could be taking a test proving understanding positions of opponents; it could be a marketing event sponsored by an advertiser; it could be a reward for wining a popularity contest by getting most “likes” form the other forum members; it could be getting recognition for the creativity of posts from the experts hired by the forum operators; it could be any other activity that forum operators select as benefiting the forum.

The history of all activities as well as users' scores is kept in the searchable database 94, accessible to all users. Furthermore, forum operators build and update a searchable database 96 of basic encyclopedic data related to the subject of the forum.

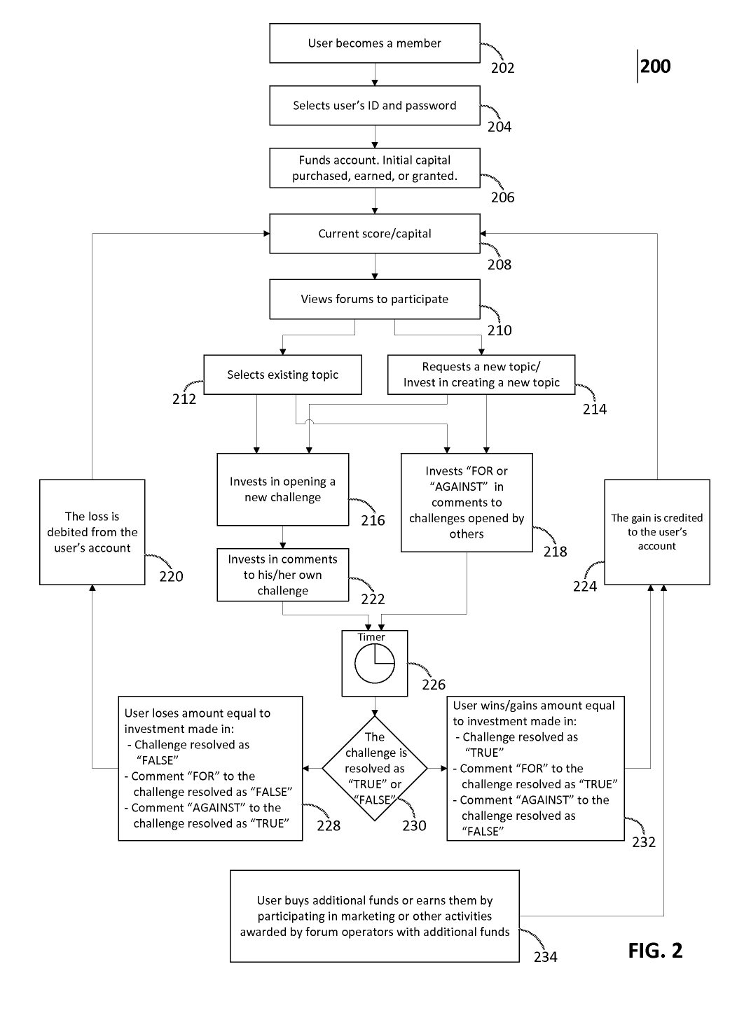

Shown now in FIG. 2 is the flow chart 200 of the inventive system Network Based Discussion Forum System and Method with Means for Improving Post Positioning and Debater Status by Arguments Trading.

The inventive debate forum can be public, where everyone has access to all posts and information available on the forum and everyone can sign in. The forum can be private or partially private, where only some information is available to the public, and only people meeting certain criteria (for example condo owners at the condominium association) can join the forum. When used by corporations or military, the very existence of the forum can be confidential and only people invited can be members of the forum. Regardless of the option, one needs to become a member 202, create the user's ID 204 and the password, and obtain the initial capital 206 in order to be able to participate 210. The new user can select the existing topic 212, or request a new topic 214; or invest in creating a new topic 214. The user can invest in opening a new challenge 216 and in posting comments 222 in the debate of this challenge, or can invest in supporting or opposing challenges 218 posted by others. The debate lasts only a predetermined time 226 and then it is decided as TRUE or FALSE 230, and the user's gains 232 and losses 228 are calculated, then credited 224 or debited 220 accordingly to the user's current capital 208. Forum operators can provide users with other activities 234, which allow users to earn additional funds.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

### PARTS LIST

### FIG. 1

10—Improved debate and discussion forum with user account funding and argument trading algorithm
11—Player 1
12—Player 2
14—Player 3
16—Player n
20—Initial capital, Player 1
22—Initial capital, Player 2
24—Initial capital, Player 3
26—Initial capital, Player n
28—Other activities allowing players to earn additional funds
30—Current score/capital, Player 1
32—Current score/capital, Player 2
34—Current score/capital, Player 3
36—Current score/capital, Player n
38—Unit and algorithm calculating users' scores
40—Investment of Player 1 in challenge 52
42—Investment of Player 2 in the comment 54 supporting challenge 52
44—Investment of Player 3 in the comment 56 opposing challenge 52
46—Investment of Player n in the comment 58 to the challenge 52 equals zero as Player
n serves as a moderator for this challenge
48—Gains (wins) and loses are determined after challenge 52 is resolved
50—Topic A
52—Challenge A.1.1
54—Comment supporting challenge 52
56—Comment opposing challenge 52
58—Comment made by the moderator, Player n
60—Timer closing the debate of challenge 52
62—Moderator decides if challenge 52 is TRUE or FALSE
64—Investment of Player 1 in the comment 78 to the challenge 80 equals zero as Player
66—Investment of Player 2 in challenge 80
68—Investment of Player 3 in the comment 82 supporting challenge 80
70—Investment of Player n in the comment 84 opposing challenge 80
72—Timer closing the debate of challenge 80
74—Gains (wins) and loses are determined after challenge 80 is resolved
76—Topic B
78—Comment made by the moderator, Player 1
80—Challenge A.2.2
82—Comment supporting challenge 80
84—Comment opposing challenge 80
86—Moderator decides if challenge 80 is TRUE or FALSE
88—Challenge A.n
90—Topic X
92—Challenge X.1
94—Database containing history of past challenges
96—Database of forum related encyclopedic information
98—Challenge X.2
100—Challenge X.n
102—Comment to challenge 100
104—Comment to challenge 100
106—Comment to challenge 100
108—Timer closing the debate of challenge 100
110—Moderator decides if challenge 100 is TRUE or FALSE
112—Gains (wins) and loses are determined after challenge 100 is resolved

### FIG. 2

200—Flow chart of the improved debate and discussion forum with user account funding and argument trading algorithm
202—User decides to sign up for the forum
204—User selects user name and password
206—User funds his or her account with initial capital
208—Current user's score/capital
210—User reviews available topics
212—User decides to participate in the open topic
214—User causes new topic to be open
216—User invest in posting a new challenge
218—User invest in posting a comment to already open challenge
220—Loss from lost bets is deducted from the user's account
222—User invest in comments to his or her own challenge
224—Gains (wins) from won bets are added to the user's account
226—Timer closing the debate of the challenge
228—User losses are determined after the challenge resolved
230—Challenge is resolved as TRUE or FALSE
232—User gains (wins) are determined after the challenge is resolved
234—Other forum activities, which allow users to earn additional funds

1. The invention claimed is: a debating method comprising a trading algorithm requiring users to invest in the truthfulness of their posts.

2. A method of claim 1; wherein:
a. users joining the debate forum need to obtain and maintain a funded user's account in the debate forum currency, which could be real currency, or score points;
b. an initial capital on the user's account can be given at the time of the user joining the forum, it can be purchased by a user in real currency, or it can be earned by a user by participating in forum activities rewarded in forum currency;

3. A method of claim 1; wherein:
a. a post opening discussion is called a challenge and it should contain a thesis, which can be determined as true or false;
b. in order to post a challenge a user needs to invest some of the user's owned forum currency in the truthfulness of the challenge;
c. in order to post a comment to the challenge, a user needs to declare support or opposition to the thesis of the challenge, and needs to invest some of the user's owned forum currency in the truthfulness or the falsehood of the challenge;
d. discussion are conducted for the predetermined period of time, and then the challenge is decided as true or false by a moderator;
e. if the challenge is resolved as true, the user posting this challenge gains the amount equal to the amount invested in the challenge; users posting comments supporting this challenge gain amounts equal to the amount invested in their comments; and the users posting comments opposing this challenge lose their investment in their comments;
f. if the challenge is resolved as false, the user posting the challenge loses the amount invested in this challenge; users posting comments supporting this challenge lose their investment in their comments; and users opposing this challenge gain amounts equal to the amount invested in their comments;

4. A method of claim 1; wherein a moderator makes one-man determination if the challenge is true or false basing on the arguments presented not on the knowledge available otherwise.

5. A method of claim 1; wherein, the debating trading algorithm is used in:
a. network based systems, wherein users access debates by using stationary or portable network access devices over the digital network as the internet or intranet;
b. physical presence systems, wherein users are gathered in a confined space for the purpose of the debate;
c. virtual systems, as computer games;
d. entertainment venues, as TV shows;
e. educational organization;
f. course of business by for profit organizations.

6. A system using the method of claim 1, comprising a server storing records of all challenges and comments in a searchable database, filling and processing challenges and comments, calculating trades associated with challenges and comments, updating accordingly users' accounts, and maintaining users access to the debate forum; wherein, the server is most likely a network based computer or a set of computers, but it could be another device or a person performing these functions manually;

7. A system of claim 6; wherein, the integrity of the debate is secured by some or all of the below measures:
a. moderators can be arbitrarily assigned by the debate forum operators;
b. moderators can be selected from the forum members, with the restriction that a user cannot be a moderator of his or her challenge, and cannot trade comments of the challenge he or she moderates;
c. comments by moderators do not require any investment in order to be posted; a moderator does not participate in the trade on in the challenge he or she moderates;
d. a challenge can have more than one moderator, but only one moderator is assigned a role of deciding if the challenge is true or false in the one-man fashion;
e. users can post a challenge questioning objectivity of a moderator;
f. users can post the same or similar challenges endlessly, as long as they believe that new data available or a different moderator can bring a different outcome than before;
g. users have access to records of challenges searched by key words;
h. users have access to records of moderators decisions and challenges posted against them;

8. A system of claim 6; wherein, forum operators can allows users to obtain additional funds in forum currency by participating in marketing events, by taking tests proving knowledge of the views of their opponents, by participating in any other event approved for that purpose by the forum operators, or by purchasing forum currency with real currency;

9. A system of claim 6; wherein:
a. endless number of parallel challenges can be processed simultaneously;
b. challenges can be associated with interest groups; kept public, have limited public access or kept private;
c. groups using the system can use some or all system features.

10. A system of claim 6; wherein, the server contains a searchable database of information related to the subject of the forum.

11. A system of claim 6; wherein, the status of the user is defined by the current amount of the forum currency at the user's account.

12. A system of claim 6; wherein:
a. the community recognition of a user is based on “like” or “dislike” votes of other users on the posts of the given user;
b. the community recognition of a user is based on publicly available records of the user posts;
c. forum operators may implement community voting allowing users donating some of their own assets to other users of their choice.
